(19) United States
(12) Patent Application Publication
(10) Pub. No.: US 2014/0124452 A1
(43) Pub. Date: May 8, 2014

(54) METHODS FOR REMOVING MERCURY FROM WASTEWATER STREAMS

(71) Applicant: GENERAL ELECTRIC COMPANY, Schenectady, NY (US)

(72) Inventors: Gerald Cecil Walterick, JR., Levittown, PA (US); Deborah Gereaghty, Delanco, NJ (US)

(73) Assignee: GENERAL ELECTRIC COMPANY, Schenectady, NY (US)

(21) Appl. No.: 13/670,943

(22) Filed: Nov. 7, 2012

(51) Int. Cl. C02F 1/52; C02F 1/46

(52) U.S. Cl. CPC C02F 1/5272; C02F 1/5245; C02F 1/46
USPC 210/703; 210/728

(57) ABSTRACT

Methods for reducing mercury content from a mercury-laden aqueous stream comprise contacting the aqueous stream with a tannin coagulant, a sulfide, such as a polyorganic sulfide, and an optional cationic flocculent. The invention is particularly well suited to reduce mercury content in mercury-containing wastewater streams of the type generated during oil and natural gas production.

### FIELD OF THE INVENTION

The present invention pertains to methods for reducing the amount of mercury in wastewater streams and has specific applicability to mercury-containing wastewater streams of the type generated during oil and natural gas production.

### BACKGROUND OF THE INVENTION

During the extraction of oil and natural gas, aqueous waste streams are often brought to the surface from the subterranean strata from which the oil and natural gas are extracted. These aqueous streams may be derived from naturally occurring water present in the strata or from water that has been injected to enhance the recovery of oil deposits. These waste streams are generally referred to as “produced water” or “formation water.” They are often contaminated with various heavy metals, including mercury. Mercury is extremely toxic to humans and other species and even very low concentrations (part per trillion) of mercury will bioaccumulate to higher toxic concentrations in an aqueous ecosystem. As a result, it is critical that mercury be removed from wastewaters before the wastewaters are discharged to the environment. In response to this concern over contaminating the environment with mercury, regulatory agencies throughout the world have enacted very strict (low part per trillion) discharge limits for wastewaters that may contain mercury. Such wastewaters include formation water and produced water from oil, natural gas, and methane production.

Another mercury contaminated aqueous waste stream occurring in gas production processes is the recycled water used to inhibit hydrate formation in the gas stream. These streams contain thermodynamic hydrate inhibitors, such as monoethylene glycol (MEG) or other glycols which are used to strip water from the gas stream. The MEG is recovered and recycled to control costs. Contaminants in the MEG water, including mercury, cycle up to higher concentrations in the MEG recovery process and must be removed prior to discharge to the environment.

In other stripping processes, methanol or another alcohol may be used in lieu of or in admixture with the glycols. The glycol and/or alcohols are commonly introduced directly into the pipeline, usually by spraying, in order to absorb water in the gas stream. The wet alcohol and/or glycol is then separated from the gas downstream from the injection point with the alcohol or glycol being regenerated via distillation or other separation techniques for subsequent recycling to the injection point. In addition to MEG, other glycols, such as triethylene glycol (TEG), diethylene glycol (DEG) or tetraethylene (TREG) can be used alone or in combination in such processes.

The mercury present in such aqueous wastewater streams may be present in several forms, including ionic, elemental, particulate, and organic. For example, crude oil may contain elemental mercury, but this may be oxidized to various water-soluble ionic salt forms during processing. Such water-soluble salts may contain monovalent and/or bivalent mercury and complexes thereof. Also, some bacteria can convert mercury from a water soluble form to a less water-soluble organic species such as methyl mercury and dimethyl mercury.

### SUMMARY OF THE INVENTION

In one exemplary embodiment of the invention, a method for reducing mercury content in a mercury-laden aqueous stream is provided. In one aspect of the invention, the mercury-laden aqueous stream is contacted with a tannin coagulant and a sulfide. In other embodiments, a cationic flocculent is conjointly used with the tannin coagulant and the sulfide. The aqueous stream is contacted with the aforementioned treatment agents and is then mixed. The aqueous stream is allowed to settle and then solids are separated from the settled aqueous stream. This results in a subnatant liquid of reduced mercury content.

In other embodiments, the tannin comprises a copolymer, such as, inter alia, a tannin/cationic copolymer. The cationic copolymer may have a cationic repeat unit moiety comprising N,N-(dimethylaminoethyl)methacrylate (MADAME), 2-methylacryloxyethyltrimethyl ammonium chloride (METAC), or 2-acryloxyethyltrimethyl ammonium chloride (AETAC).

In other embodiments, the tannin coagulant may comprise a reaction product of tannin, an aldehyde, and an amine, such as a primary amine. In further embodiments, the tannin reaction product comprises a reaction product of tannin/monoethanolamine and formaldehyde.

In other aspects of the invention, the sulfide is a polyorganosulfide and, in further embodiments, the polyorganosulfide is a polydithiocarbamate. In one embodiment, the polydithiocarbamate is a reaction product of polyethylenimine and carbon disulfide. In some instances, the polydithiocarbamate has a CS₂ functionality of about 80% and a molecular weight of greater than 100,000 daltons.

As to the cationic flocculent that may be used in certain embodiments, this can comprise a copolymer or terpolymer having an optional hydrophobic monomer repeat unit, an acrylamide repeat unit, and a quaternary ammonium salt repeat unit.

Further embodiments include conjoint use of an aluminum- or iron-containing coagulant with the above identified treatment agents.

The invention has found particular applicability for use in mercury-laden aqueous streams of the type that comprise a glycol- or alcohol-containing stream from a natural gas or oil producing process.

### DETAILED DESCRIPTION OF THE INVENTION

In one embodiment of the invention, a method is provided to reduce mercury from a mercury-laden aqueous stream. This stream is contacted by a sulfide, such as a polyorganosulfide. In one embodiment, the polyorganosulfide is a water soluble polymeric dithiocarbamic acid salt (PDTC). In some embodiments, the PDTC may be formed by reacting poly[ethylenimine] (PEI) with carbon disulfide in the presence of a base to yield water-soluble, branched, polymeric dithiocarbamic acid salts represented by the following general formula:

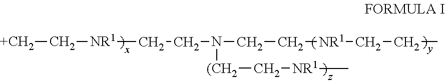

R¹ independently represents —H or —CS₂R² which may be the same or different for each representation; R² each independently represents H or a cation; and preferably the sum of x, y and z is an integer greater than 15. Preferably, the molecular weighty of the PDTC is greater than 100,000 dalton units.

In a preferred embodiment of the invention >50 mole percent of R¹ are —CS₂R², R² is an alkali metal, and the sum of x, y and z is an integer greater than 100.

In a particularly preferred embodiment of the invention ≧80 mole percent of R¹ are —CS₂R², R² is an alkali metal, and the sum of x, y and z is an integer greater than 500.

More details pertaining to the synthesis of these PDTCs may be gleaned from review of U.S. Pat. No. 5,594,096 and, specifically, Table I thereof. The disclosure of this patent is incorporated by reference therein.

In some embodiments, from about 0.1-500 parts per million (ppm) of the PDTC is brought into contact with the mercury-laden wastewater stream based upon one million parts of such stream. In other embodiments, from about 5-250 ppm of the PDTC is brought into contact with this aqueous stream.

In other aspects of the invention, a tannin coagulant is conjointly employed with the PDTC to contact the mercury-laden aqueous stream. Exemplary tannin coagulants include tannin polymers, such as cationic tannin copolymers (CTC). These CTCs are water soluble or water dispersible and comprise a copolymer of tannin and a cationic monomer.

In another embodiment of the present invention, the water soluble or dispersible tannin containing polymer composition comprises a polymer of tannin; a cationic monomer and an optional monomer selected from the group consisting of an anionic monomer and a nonionic monomer. These tannin polymers are described in U.S. Pat. No. 5,916,991 ('991).

As stated in '991, the cationic monomer is selected from a group containing ethylenically unsaturated quaternary ammonium, phosphonium or sulfonium ions. Typical cationic monomers are quaternary ammonium salts of dialkylaminoalkyl(meth)acrylamides, dialkylaminoalkyl(meth)acrylates and diallyldialkyl ammonium chlorides.

Exemplary cationic monomers include diethylaminoethyl acrylate, dimethylaminoethyl acrylate (AETAC), dimethylaminoethyl methacrylate (MADAME), diethylaminoethyl methacrylate (METAC), dimethylaminopropyl methacrylamide and dimethylaminopropyl acrylamide and quaternary ammonium salts of the above. Further, diallyldimethyl ammonium chloride (DADMAC) and diallyldiethyl ammonium chloride can also be mentioned.

The anionic monomer, when present, is selected from the group containing ethylenically unsaturated carboxylic acid or sulfonic acid functional groups. These monomers include but are not limited to acrylic acid, methacrylic acid, vinyl acetic acid, itaconic acid, maleic acid, allylacetic acid, styrene sulfonic acid, 2-acrylamido-2 methyl propane sulfonic acid (AMPS®) and 3-allyloxy-2hydroxypropane sulfonic acids and salts thereof.

The nonionic monomer, when present, is selected from the group of ethylenically unsaturated nonionic monomers which comprise but are not limited to acrylamide, methacrylamide, N-methylolacrylamide, N,N-dimethyl-acrylamide; lower alkyl (C₁-C₆) esters including vinyl acetate, methyl acrylate, ethyl acrylate, and methyl methacrylate; hydroxylated lower alkyl (C₁-C₆) esters including hydroxyethyl acrylate, hydroxypropyl acrylate and hydroxyethyl methacrylate; allyl glycidyl ether; and ethoxylated allyl ethers of polyethylene glycol, polypropylene glycol and propoxylated acrylates. The preferred nonionic monomers are allyl glycidyl ether and acrylamide

The resulting tannin containing polymer contains from 10 to 80% by weight of tannin, 20 to 90% by weight of cationic monomer, 0 to 30% by weight of nonionic monomer and 0 to 20% by weight of anionic monomer, provided that the resulting tannin containing polymer is still water soluble or dispersible, and the total weight percent of cationic, nonionic and anionic monomers and tannin adds up to 100%. Preferably, when the cationic monomer and anionic monomer are present together in the tannin containing polymer, the cationic monomer comprises a greater weight percentage than the anionic monomer.

Exemplary cationic tannin copolymers include copolymers of tannin and cationic monomer wherein the copolymer contains from 50 to 90 wt % cationic monomer in the copolymer, provided the total weight of tannin and cationic monomers totals 100 wt %. These particular copolymers are most preferred when the tannin is a Mimosa type tannin and the cationic monomer is methyl chloride quaternary salt of dimethylaminoethyl acrylate (AETAC).

The number average molecular weight of the resulting tannin containing polymer is not critical as long as it is still water soluble or water dispersible. The tannin containing polymers may be prepared by mixing the desired monomers with tannin and initiating the polymerization by a free radical initiator via solution, precipitation, or emulsion polymerization techniques. Conventional initiators such as azo compounds, persulfates, peroxides, and redox couples may be used. One exemplary initiator is 2,2′azobis(2-amidinopropane)dihydrochloride and t-butylhydroperoxide/sodium metabisulfite (t-BHP/NaMBS). These or other initiators may be added at the end of polymerization to further react with any residual monomers.

Chain transfer agents such as alcohol, amine, formic acid, or mercapto compounds may be used to regulate the molecular weight of the polymer. The resulting polymer may be isolated by well known techniques including precipitation, etc., or the polymer may simply be used in its aqueous solution.

The reaction temperature is not critical and generally occurs between 20° C. and 100° C., preferably 40° C. to 70° C. The pH of the reaction mixture is also not critical and is generally in the range of 2.0 to 8.0. The resulting tannin containing polymers are characterized by C-13 NMR, Brookfield viscosity and percent solids.

Noteworthy tannin copolymers are graft copolymers of AETAC and mimosa tannin wherein the AETAC monomeric repeat unit in the copolymer is present in an amount of by weight of greater than 50%. Exemplary copolymers have cationic charge densities of 50%, 57.5%, and 70% (by weight) respectively. These copolymers range in MW from about 50,000-70,000 daltons.

Another particularly noteworthy tannin polymer is a tannin based polymeric coagulant which is comprised of N,N-(dimethylaminoethyl)methacrylate (MADAME) polymerized using t-butylhydroperoxide and sodium metabisulfite. The resulting polyMADAME is converted to hydrochloride and then blended/reacted in an aqueous medium with tannin to obtain a homogenous poly(MADAME)-tannin composition. The mole ratio of tannin/MADAME is about 1:0.5 to 1:50, with a preferred mole ratio of 1:1.5 to about 1:3. Molecular weight is from about 500 to about 2,000,000, preferably 5,000-200,000. Quaternary ammonium salts of MADAME may also be mentioned.

Another exemplary tannin is comprised of monomer [2-(methacryloyloxy)ethyl] trimethylammonium chloride (METAC) polymerized using t-butylhydroperoxide and sodium metabisulfite. The resulting polyMETAC is then blended/reacted in an aqueous medium to obtain a homogenous poly(METAC)-tannin composition. The mole ratio of tannin/METAC is from about 1:0.5 to about 1:5.0 with a preferred mole ratio of 1:1.5 to about 1:3. Molecular weight of the polyMETAC is from about 500 to about 2,000,000 with a preferred molecular weight of about 5,000 to about 200,000.

Other exemplary tannin coagulants are those made via reaction of tannin, an amine, and an aldehyde such as those set forth in U.S. Pat. No. 4,558,080. In accordance with the ‘080 patent, these components are reacted at an acidic pH and where the molar ratio of amine, such as a primary amine, to tannin present is from about 1.5:1-3.0:1. Exemplary tannin/amine compounds include tannin/melamine/formaldehyde polymers and tannin/monoethanolamine/formaldehyde polymers

The tannin coagulant is brought into contact with the mercury-laden stream in an amount of about 5-2000 ppm based upon one million parts of the oily aqueous stream. In other embodiments, the tannin polymer is employed in an amount of between about 50-250 ppm.

In some embodiments of the invention, the mercury-laden aqueous stream is contacted with an inorganic aluminum or iron containing coagulant. Exemplary aluminum or iron containing inorganic coagulants include aluminum sulfate, sodium aluminate, alum, aluminum chloride, polyaluminum chloride, ferrous sulfate, ferric sulfate, ferric chloride, etc. In some embodiments, these coagulants may be employed in an amount of about 100-2000 ppm, with an even more specific amount of about 300-1000 ppm, being mentioned; all based upon one million parts of the mercury-laden aqueous stream.

In certain exemplary embodiments, a water soluble cationic flocculant such as cationic acrylamide flocculant (CAF), can also be employed and brought into contact with the mercury-containing aqueous stream. For example, these polymers are mentioned in U.S. Pat. Nos. 5,720,887 and 5,368,744 of common assignment herewith; both of these patents are incorporated by reference herein. These CAF polymers can be represented by the formula below.

The CAF has the general structure:

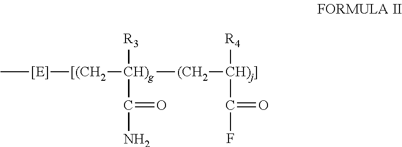

wherein E is a polymeric segment obtained from the polymerization of hydrophobic or water insoluble monomers. Examples of such monomers include alkyl acrylamides, alkyl methacrylamides, alkyl acrylates, alkyl methacrylates, and alkylstyrenes. Preferably, the hydrophobic monomer is an alkyl acrylate having 4 to about 16 carbon atoms in the alkyl group such as 2-ethylhexyl acrylate. Other suitable hydrophobic or water insoluble monomers include the higher alkyl esters of ethylenically unsaturated carboxylic acids such as alkyl dodecyl acrylate, dodecyl methacrylate, tridecyl acrylate, tridecyl methacrylate, octadecyl acrylate, octadecyl methacrylate, ethyl half ester of maleic anhydride, diethyl maleate, and other alkyl esters derived from the reactions of alkanols having from 8 to 20 carbon atoms with ethylenically unsaturated carboxylic acids such as acrylic acid, methacrylic acid, maleic anhydride, fumaric acid, itaconic acid and aconitic acid, alkylaryl esters of ethylenically unsaturated carboxylic acids such as nonyl-α-phenyl acrylate, nonyl-α-phenyl methacrylate, dodecyl-α-phenyl acrylate and dodecyl-α-phenyl methacrylate; N-alkyl, ethylenically unsaturated amides such as N-octadecyl acrylamide, N-octadecyl methacrylamide, N,N-dioctyl acrylamide and similar derivatives thereof; vinyl alkylates wherein alkyl has at least 8 carbons such as vinyl laurate and vinyl stearate, vinyl alkyl ethers such as dodecyl vinyl ether and hexadecyl vinyl ether; N-vinyl amides such as N-vinyl lauramide and N-vinyl stearamide; and aralkylstyrenes such as t-butyl styrene. Of the foregoing hydrophobic monomers, the alkyl esters of acrylic acid and methacrylic acid wherein alkyl has from 4 to 16 carbon atoms, are preferred. F is a salt of an ammonium cation. The hydrophobic polymers are not water soluble and can be prepared by precipitation or emulsion polymerization techniques.

E may be present in a molar amount of about 0-15%, g may be present in a molar amount of about 10-90%, and j may be present in a molar amount of about 10-90%. E, g, and j=100 molar %.

Monomer g in the Formula II is a non-ionic monomer such as acrylamide or alkylacrylamide. R₃ and R₄ is H or a lower alkyl group having C₁ to C₃. Monomer j is a cationic monomer. F in the above formula is a salt of an ammonium cation. Typical cationic monomers j are 2-acryloxyethyltrimethyl ammonium chloride (AETAC), 3-methacrylamidopropyltrimethyl ammonium chloride (MATAC), 2-methacryloylethyltrimethyl ammonium chloride (METAC) and diallyl dimethyl ammonium chloride (DADMAC), etc.

At present, the preferred water soluble block copolymer is:

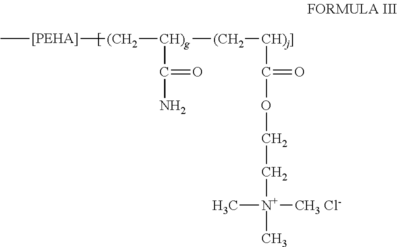

wherein PEHA is poly(2-ethylhexyl acrylate) obtained from polymerization of 2-ethylhexyl acrylate (EHA) initiated by a diperoxide initiator, 2,5-dihydroperoxy-2,5-dimethylhexane (Luperox 2,5-2,5, Pennwalt). The resulting poly(EHA) is water insoluble and has a hydrophobic nature. The number average molecular weight (Mn) of poly(EHA) may fall within the range of 500 to 1,000,000. Preferably, the number average molecular weight will be within the range of 1,000 to 500,000, with the range of about 5,000 to about 200,000 being even more desirable. The key criterion is that the resulting block copolymer be water soluble. Since the diperoxide initiator is used to initiate EHA, the resulting poly(EHA) still contains peroxide for further reaction. It is then copolymerized with monomers x and y to form a block copolymer.

The molecular weight of the copolymer or terpolymer CAF may vary over a wide range, for example, 10,000-20,000,000. Usually, the copolymers will have molecular weights in excess of 1,000,000. The cationic flocculant copolymer should be water soluble or dispersible. It is present practice to employ the cationic flocculant copolymer (I) in the form of a water in oil emulsion. The oil phase may comprise hydrotreated isoparaffins and napthenics with a low level of aromatics.

Additional cationic flocculants that may be mentioned include polyEPI/DMA (a copolymer of epichlorohydrin and dimethylamine), and acrylamide/allyl trialkyl ammonium copolymer or an acrylamide diallyldialkyl ammonium copolymer. The molecular weights of these cationic flocculants may for example range from about 10,000 to 20,000,000.

The cationic flocculants may, in general, be brought into contact with the mercury-containing water in an amount of about 0.1-250 ppm, with an amount of about 1-50 ppm, based on one million parts of the mercury water stream being preferred.

Generally, the method pertains to reduction of mercury content in waste streams of the type generated during oil and gas production. Exemplary methods entail treating a wastewater, formation water, or produced water by adding to the water a tannin-based coagulant and a polyorganosulfide product, mixing the treated water for a time sufficient to allow the additives to react with the mercury and other contaminants present in the water, further mixing for sufficient time to allow formation of an insoluble mercury-containing precipitate, then stopping the mixing and separating the precipitates from the bulk water by sedimentation, flotation, centrifugation, filtration, etc. As per above, in some cases, the method may also include addition of an inorganic aluminum- or iron-based coagulant and/or a flocculant.

Although Applicants are not to be bound to any particular theory of operation, it is thought that the treatment additives discussed above form a complex with the mercury contaminants present in the water resulting in the formation of an insoluble precipitate or co-precipitate that can be readily separated from the bulk water by traditional liquid/solids separation techniques. The tannin coagulants and the polyorganosulfide treatment additives are thought to be complimentary in their mechanisms for removing mercury. The tannin-based coagulants are particularly effective for removing mercury compounds that have partitioned into the hydrocarbon phase of the wastewater. The organosulfide products are most effective in precipitating soluble mercury that is present in the aqueous phase of the wastewater as Hg⁺⁺. The combination of the two treatment additives results in much lower residual mercury concentrations than could be achieved by either additive added by itself.

The invention will now be further described in the following examples which are regarded as illustrative of certain embodiments of the invention and which should not be construed as limitations on the scope of the invention.

### EXAMPLES

### Example 1

A 500 ml sample of MEG water containing 8800 ppt total Hg was added to each of seven beakers. The beakers containing the MEG were then placed on a gang-stirrer equipped with mixing paddles for each beaker. A tannin polymer/polyaluminum chloride blend was added to each sample at the dosages indicated in the Table. Each treated sample was mixed for eight minutes. While continuing to mix, polyorganosulfide was added at the dosages indicated in the Table. Each sample was mixed for five minutes. While continuing to mix, cationic polyacrylamide was added at the dosages indicated in the Table. Each treated sample was mixed for six minutes. Mixing was then stopped and the mixing paddles were removed from the beakers. The samples were allowed to set for 30 minutes under quiescent conditions to allow the solids to separate from the bulk water via flotation. Samples of the subnatant water were obtained for residual mercury analysis.

TABLE 1

| | | | | Residual | Float | Residual Mercury | |
|---|---|---|---|---|---|---|---|
| | TPAC | POS | CAF | Turbidity | Solids | Total | Soluble |
| Test # | ppm | ppm | ppm | ntu | ml | ng/l | ng/l |
| C-1 | 1000 | — | 5 | 6.9 | ~75 | 1580 | 1160 |
| X-1 | 1000 | 5 | 5 | 8.5 | ~75 | 1770 | 178 |
| X-2 | 1000 | 10 | 5 | 9.77 | ~75 | 1770 | 105 |
| X-3 | 1000 | 20 | 5 | 11.7 | ~75 | 1760 | 84.0 |
| X-4 | 1000 | 50 | 5 | 15.2 | ~75 | 1860 | 76.7 |
| X-5 | 1000 | 100 | 5 | 18.1 | ~75 | 1700 | 624 |
| X-6 | 1000 | 200 | 5 | 27.2 | ~75 | 1850 | 850 |

| | | |
|---|---|---|
| RAW WATER | 8800 | 3700 |

Raw glycol water was spiked with 10 ppb (10,000 ng/L) mercury prior to testing.

TPAC=tannin polymer/polyaluminum chloride −80% polyaluminum chloride/20% tannin-AETAC copolymer; the polyaluminum chloride (PAC) is an aqueous solution of partially neutralized aluminum chloride. The PAC has a basicity of 63% and contains 18.5-20.1% Al₂O₃. Molecular weight of the tannin/AETAC is ≈70,000 daltons.

POS=polyorganosulfide−dithiocarbamate (DTC)−polyethylenimine (PEI) CS₂ reaction product with 80% CS₂ functionality; molecular weight >100,000 daltons.

CAF=cationic polyacrylamide (AM); AETAC/acrylamide; (AM)/polyethylhexylacrylate (PEHA); molar ratio AETAC/AM/PEHA=50/43/7; molecular weight ˜4-6 million daltons.

What is claimed is:

1. A method for reducing mercury content from a mercury-laden aqueous stream comprising:
contacting said mercury-laden aqueous stream with
(i) a tannin coagulant; and
(ii) a sulfide.

2. A method as recited in claim 1 further comprising contacting said mercury-laden aqueous stream with a cationic flocculent, mixing said aqueous stream, allowing said aqueous stream to settle and then separating solids from said settled aqueous stream, providing a subnatant liquid of reduced mercury content.

3. A method as recited in claim 2 wherein said tannin coagulant comprises a tannin copolymer.

4. A method as recited in claim 3 wherein said tannin copolymer is a tannin/cationic copolymer.

5. A method as recited in claim 4 wherein said tannin/cationic copolymer has a cationic repeat unit moiety comprising MADAME, METAC, or AETAC.

6. A method as recited in claim 5 wherein said cationic repeat unit moiety is MADAME.

7. A method as recited in claim 4 wherein said cationic repeat unit moiety is METAC.

8. A method as recited in claim 4 wherein said cationic repeat unit moiety is AETAC.

9. A method as recited in claim 1 wherein said tannin coagulant is a reaction product of tannin, an aldehyde, and an amine

10. A method as recited in claim 9 wherein said tannin comprises a reaction product of tannin, aldehyde, and a primary amine.

11. A method as recited in claim 10 wherein said tannin comprises a reaction product of tannin, formaldehyde, and monoethanolamine.

12. A method as recited in claim 2 wherein said sulfide comprises a polyorganosulfide.

13. A method as recited in claim 12 wherein said polyorganosulfide is a polydithiocarbamate.

14. A method as recited in claim 13 wherein said polydithiocarbamate is a reaction product of polyethylenimine and CS₂.

15. A method as recited in claim 14 wherein said polydithiocarbamate has a CS₂ functionality of about 50% and a molecular weight of greater than about 100,000 daltons.

16. A method as recited in claim 2 wherein said cationic flocculant comprises a cationic acrylamide copolymer or terpolymer.

17. A method as recited in claim 16 wherein said cationic flocculent comprises a quaternary ammonium salt repeat unit.

18. A method as recited in claim 2 further comprising contacting said mercury-laden aqueous stream with an aluminum- or iron-containing coagulant.

19. A method as recited in claim 2 wherein said mercury-laden aqueous stream comprises a glycol- or alcohol-containing stream from a natural gas or oil producing process.

20. A method as recited in claim 1 further comprising:
mixing said aqueous stream for a sufficient time to allow formation of an insoluble mercury-containing precipitate, and
separating said insoluble mercury-containing precipitate from the aqueous stream by one or more liquid/solids separation processes selected from the group consisting of:
(i) dissolved gas flotation
(ii) induced air flotation
(iii) electrolytic flotation
(iv) centrifugation
(v) filtration and
(vi) gravity sedimentation
